(19) United States
(12) Patent Application Publication
(10) Pub. No.: US 2009/0291641 A1
(43) Pub. Date: Nov. 26, 2009

(54) Mobile terminal and indoor/outdoor judgment method

(75) Inventors: Takahiro Sato, Kanagawa (JP); Takuji Mochizuki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/385,992

(22) Filed: Apr. 27, 2009

(30) Foreign Application Priority Data
May 23, 2008 (JP) 2008-135640

(51) Int. Cl. H04B 17/00; H04M 1/00

(52) U.S. Cl. 455/67.11; 455/556.1

(57) ABSTRACT

A mobile terminal 1 includes a power measurement part which measures a received power of a radio signal received from outside, a movement estimator which estimates a moving state of the mobile terminal from an information included in the radio signal, and a judgment part which judges whether the mobile terminal is located in an indoor location or an outdoor location, based on the received power and the moving state.

### INCORPORATION BY REFERENCE

This application is based upon and claims the benefit of priority from Japanese Patent Application No. 2008-135640 which was filed on May 23, 2008, the disclosure of which is incorporated herein in its entirety by reference.

### BACKGROUND OF THE INVENTION

1. Field of the Invention

The present invention relates to a mobile terminal and an indoor/outdoor judgment method, or more specifically, to a mobile terminal which judges whether the mobile terminal is located indoors or outdoors by using a radio signal received from outside, and an indoor/outdoor judgment method.

2. Description of Related Art

In the following, techniques 1 and 2 related to indoor/outdoor judgment will be sequentially described.

### [Related Technique 1]

A vehicle navigation apparatus 5 shown in FIG. 6 includes a GPS (global positioning system) receiver 11 which receives a radio signal for positioning (hereinafter referred to as a positioning signal) SG1 from a GPS satellite 4 through an antenna ANT, and which detects the current location of a vehicle on the basis of this signal SG1. The apparatus 5 includes a judgment part 14a which judges whether the vehicle is located indoors or outdoors by checking location information I1 outputted from this receiver 11 against map information I2 read from a map database DB and which outputs a judgment result DR thereof.

In operation, the judgment part 14a judges that the vehicle is located indoors in the case where the latitude, longitude, altitude, and the like indicated in the location information I1 correspond to an internal region of a building or the like indicated in the map information I2, and, otherwise, judges that the vehicle is located outdoors (see Patent Document 1, for example).

### [Related Technique 2]

A mobile terminal 1a shown in FIG. 7 includes a GPS receiver 11 and a judgment part 14a which are similar to those in FIG. 6, and a map information acquisition part 15 which acquires the map information I2 from a base station 6 capable of accessing the map database DB through an antenna ANT3.

In operation, before the judgment part 14a makes the indoor/outdoor judgment, the map information acquisition part 15 transmits a map information acquisition request REQ to the base station 6, and receives the map information I2 as a response thereto. Then, the judgment part 14a judges whether the mobile terminal 1a is located indoors or outdoors by checking the location information I1 against the map information 12 as similar to the above-described related technique 1 (see Patent Document 2, for example).
[Patent Document 1] Japanese Patent No. 3250553
[Patent Document 2] Japanese Patent Application Laid Open No. 2004-144602
[Patent Document 3] Japanese Patent Application Laid Open No. 2007-232592

### SUMMARY

However, the above-described related technique 1 has the problems shown below in (A) to (C), while the above-described related technique 2 has the problems shown below in (B), (C), and (D).
(A) A large-capacity storage device for storing the map information is required. This is because the map information includes highly accurate building data and also includes an enormous amount of data for covering a broad area such as entire Japan. Accordingly, it is difficult to apply this technique to a mobile terminal.
(B) It is necessary to update the map information in conformity to change (new construction, rebuilding or demolition) of the buildings in an actual site.
(C) A time lag behind the actual condition occurs accompanying an update delay of the map information in the aforementioned (B), and generates a period in which the indoor/outdoor judgment cannot be executed correctly. This is because an on-site check or measurement is required when the map information is updated. Currently, these check and measurement are carried out manually and implementation thereof requires a very great deal of time.
(D) It is necessary to construct communications infrastructures for distributing the map information.

Incidentally, as a reference example, Patent Document 3 discloses a system of making indoor/outdoor judgment according to a positioning method used by a mobile terminal in positioning of the location information.

A mobile terminal according to an exemplary aspect of the present invention includes power measurement part which measures a received power of a radio signal received from outside; a movement estimator which estimates a moving state of the terminal itself from information included in the radio signal; and a judgment part which judges whether the terminal itself is located indoors or outdoors based on the received power and the moving state.

Meanwhile, an indoor/outdoor judgment method according to an exemplary aspect of the present invention provides an indoor/outdoor judgment method for a mobile terminal. This indoor/outdoor judgment method includes a first step of measuring a received power of a radio signal received from outside the mobile terminal; a second step of estimating a moving state of the mobile terminal from information included in the radio signal; and a third step of judging whether the mobile terminal is located indoors or outdoors based on the received power and the moving state.

Specifically, the exemplary aspects are accomplished by focusing on the point that the received power of the radio signal from outside the mobile terminal varies depending on the presence and absence of a shielding object and on the point that the moving state of the mobile terminal varies depending on whether the mobile terminal is operated indoors or outdoors. The indoor/outdoor judgment can be made by using a combination of these received power and moving state. Therefore, the above-described map information is not necessary, and erroneous judgments accompanying the update delay thereof do not occur.

According to the exemplary aspects of the present invention, it is possible to carry out the indoor/outdoor judgment accurately without using the map information. Moreover, the exemplary aspects of the present invention do not require implementation of a large-capacity storage device on the mobile terminal and construction of new communications infrastructures, and therefore increases in circuit scales and development costs can be avoided.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a block diagram showing a configuration example of a network to which a mobile terminal according to the present invention is applied;

FIG. 2 is a block diagram showing a configuration example of the mobile terminal according to the present invention;

FIG. 3 is a flowchart showing an operation example of the mobile terminal according to the present invention;

FIG. 4 is a graph showing an example of a correlation between a relative received power and a measurement environment thereof used for indoor/outdoor judgment of the mobile terminal according to the present invention;

FIG. 5 is a graph showing an example of a correlation between a movement distance and an estimation environment thereof used for the indoor/outdoor judgment of the mobile terminal according to the present invention;

FIG. 6 is a block diagram showing a configuration example of a vehicle navigation apparatus according to a related technique 1 of the present invention; and

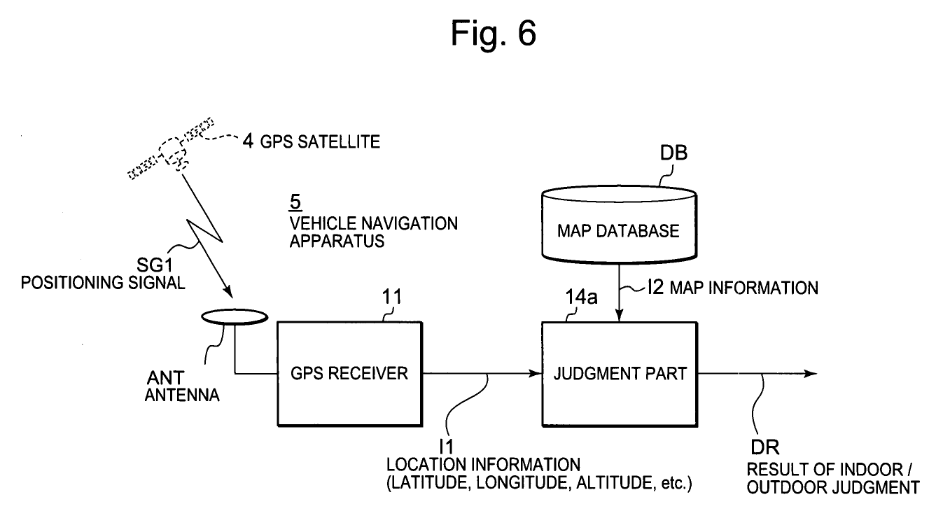

FIG. 7 is a block diagram showing a configuration example of a mobile terminal according to a related technique 2 of the present invention.

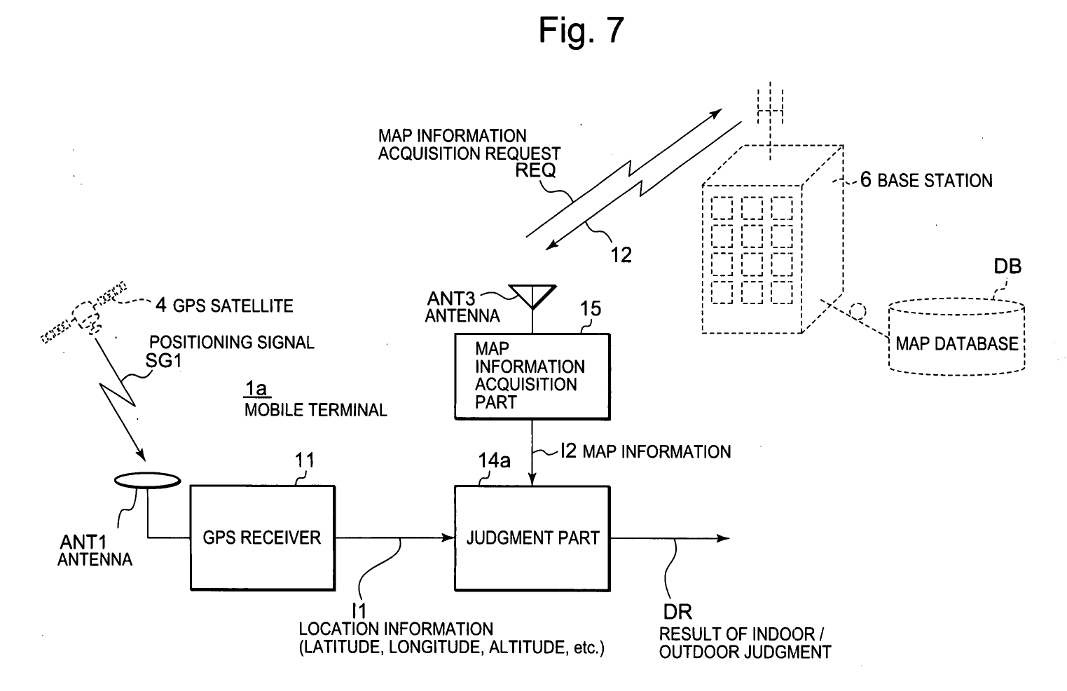

### DETAILED DESCRIPTION OF THE EXEMPLARY EMBODIMENTS

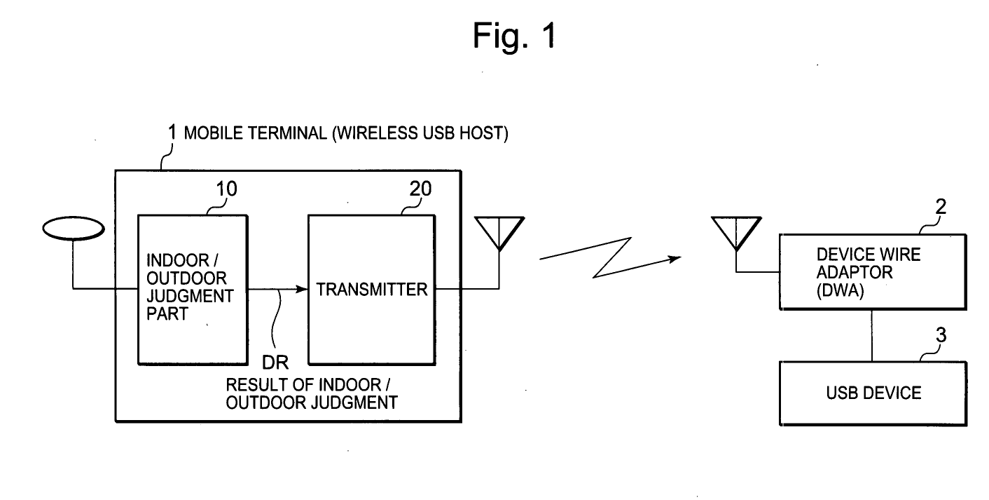

Now, an exemplary embodiment of a mobile terminal according to the present invention will be described below with reference to FIG. 1 to FIG. 5. Note that identical constituents in the respective drawings are given identical reference numerals, and duplicate explanation will be omitted as appropriate in order to clarify the description.

FIG. 1 shows an example of a network configuration to which a mobile terminal 1 according to this exemplary embodiment is applied as a wireless USB (universal serial bus) host employing the UWB (ultra wide band) scheme. In this network, the mobile terminal 1 wirelessly controls a USB device 3 via a device wire adaptor (DWA) 2 and utilizes various functions of the USB device 3. Here, a control target by the mobile terminal 1 may be a wireless USB device with a protocol interpretation function for the DWA 2 incorporated. The following description will be applied similarly to this case as well.

Meanwhile, the mobile terminal 1 includes an indoor/outdoor judgment part 10 which judges whether the mobile terminal itself is located indoors or outdoors, and a transmitter 20 which changes a power of a radio signal (hereinafter referred to as a transmission signal as the case may be) to be sent to the DWA 2 in response to a judgment result DR by this indoor/outdoor judgment part 10. Although not illustrated herein, the mobile terminal 1 also includes a receiver which receives and processes a radio signal sent from the DWA 2.

With this configuration, use of a UWB device is conventionally restricted to indoor use in Japan for the purpose of avoiding radio wave interference (more specifically, the Radio Law requires operation of a UWB device in a state where, in a cell of a radio network configured of a wireless USB host, multiple device wire adaptors and the like, at least one of these devices is connected to AC). Against this, a mobile terminal according to this exemplary embodiment is usable even outdoors without causing the radio wave interference as will be described later. For this reason, AC connection for ensuring the indoor use becomes unnecessary. Here, the reason for the restriction of the use of the UWB device to indoor use is that the power of signals transmitted from the UWB device is attenuated by a shielding object such as a wall of a house when the signals leak from indoors to outdoors, and accordingly an impact of the radio wave interference on an existing wireless system is reduced.

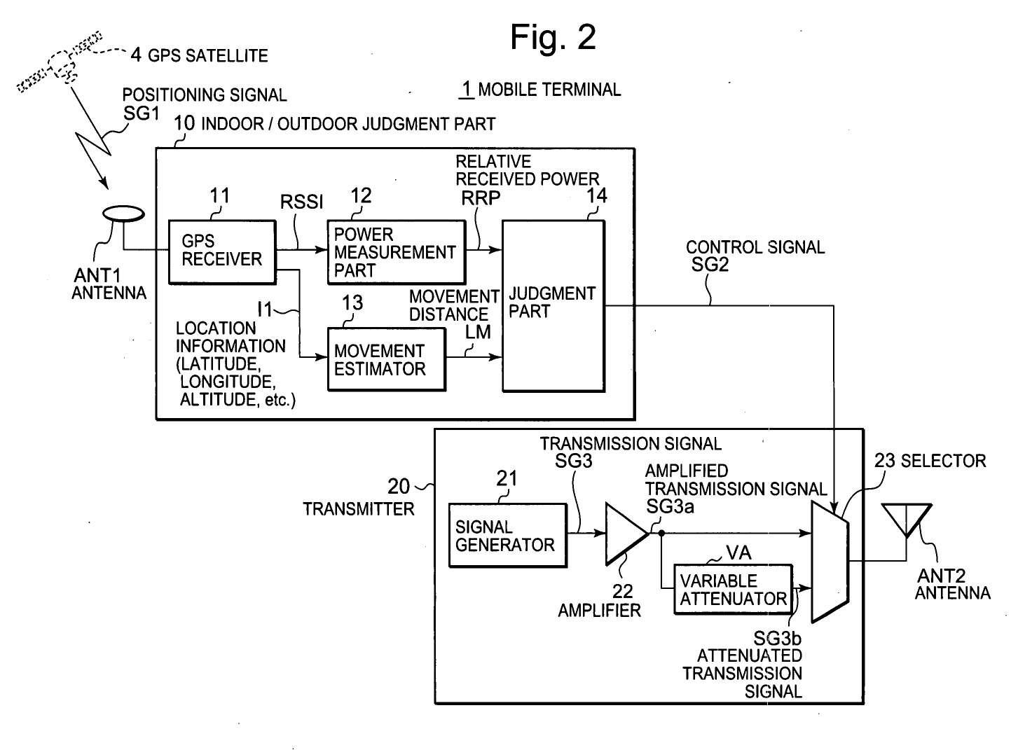

Now, more detailed examples of a configuration and operation of the mobile terminal 1 shown in FIG. 1 will be described below with reference to FIG. 2 to FIG. 5.

As shown in FIG. 2, the indoor/outdoor judgment part 10 constituting the mobile terminal 1 includes: a GPS receiver 11 which receives a positioning signal SG1 from a GPS satellite 4 through an antenna ANTI and which detects a current location of the mobile terminal 1 on the basis of this signal SG1; a power measurement part 12 which converts an RSSI (received signal strength indication) of the positioning signal SG1 into a relative received power RRP relative to a reference power; a movement estimator 13 which calculates a movement distance LM as a moving state of the mobile terminal 1 from location information (latitude, longitude, altitude, and the like) I1 outputted from the GPS receiver 11; and a judgment part 14 which judges whether the mobile terminal 1 is located indoors or outdoors on the basis of the relative received power RRP and the movement distance LM and which outputs a control signal SG2 indicating that judgment result. Moreover, the movement estimator 13 has a storing means (for example, a memory) inside and saves the location information such as the latitude, the longitude and the altitude outputted from the GPS receiver 11 as a history. Then, in a case where location information is newly received from the GPS receiver 11, the movement estimator 13 calculates the movement distance LM of the mobile terminal 1 on the basis of the past location information read from the memory and the newly received location information. For example, the movement estimator 13 calculates the current location and the location in the previous session of the mobile terminal 1 from the latitude and the longitude included in the newly received location information and the latitude and the longitude included in the location information received in the previous session, and calculates the movement distance LM by finding a difference between the current location and the location in the previous session.

Here, in this exemplary embodiment, a received power of the positioning signal SG1 (for example, “−130 dBm”) outdoors in a clear weather is assumed to be set as the above-mentioned reference power. Note that the indoor/outdoor judgment part 10 may be provided with a circuit in which positioning is performed by use of various radio navigations (for example, a radio navigation in which positioning is performed by using radio signals sent from base stations, broadcast stations, and the like) instead of the GPS receiver 11. Meanwhile, the movement estimator 13 may be configured to calculate a movement speed of the mobile terminal 1 instead of the movement distance LM. The following description will be applied similarly to this case as well.

Meanwhile, the transmitter 20 includes: a signal generator 21 which generates a desired transmission signal SG3 to the DWA 2 shown in FIG. 1; an amplifier 22 which amplifies the transmission signal SG3; and a selector 23 which inputs a transmission signal (hereinafter referred to as an amplified transmission signal) SG3a amplified by the amplifier 22 from one input terminal, which also inputs a transmission signal (hereinafter referred to as an attenuated transmission signal) SG3b attenuated by a variable attenuator VA from the other input terminal, and which selects and sends the amplified transmission signal SG3a or the attenuated transmission signal SG3b through an antenna ANT2 according to the control signal SG2.

Here, it is assumed, as the above-mentioned variable attenuator VA, that an attenuator is used which is capable of obtaining a power attenuation amount equivalent to or larger than that of a shielding object such as a wall of a house as an attenuation amount of the attenuated transmission signal SG3b.

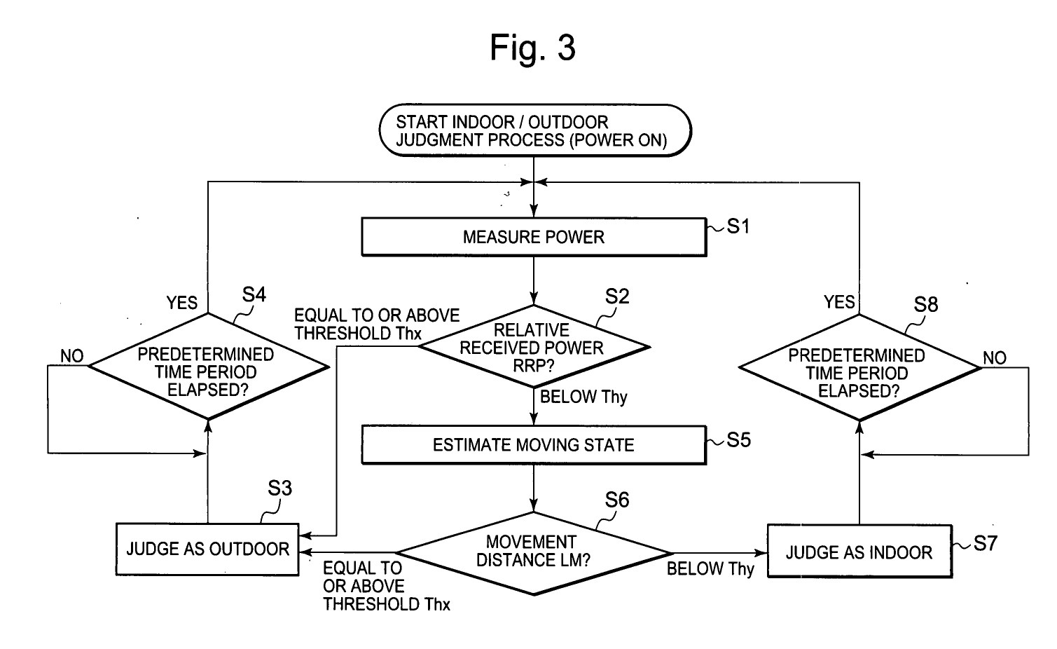

Next, operations of the mobile terminal 1 shown in FIG. 2 will be described with reference to FIG. 3 to FIG. 5.

When the power of the mobile terminal 1 is turned on as shown in FIG. 3, the GPS receiver 11 inside the indoor/outdoor judgment part 10 receives the positioning signal SG1 from the GPS satellite 4 and gives the RSSI of the signal SG1 to the power measurement part 12 while gives the location information I1 obtained on the basis of the signal SG1 to the movement estimator 13.

At this time, the power measurement part 12 converts the RSSI to the above-described relative received power RRP relative to the reference power and gives the relative received power RRP to the judgment part 14 (Step S1).

Upon receipt thereof, the judgment part 14 judges whether the mobile terminal 1 is located outdoors or possibly located indoors by comparing the relative received power RRP with a predetermined threshold Thx (Step S2).

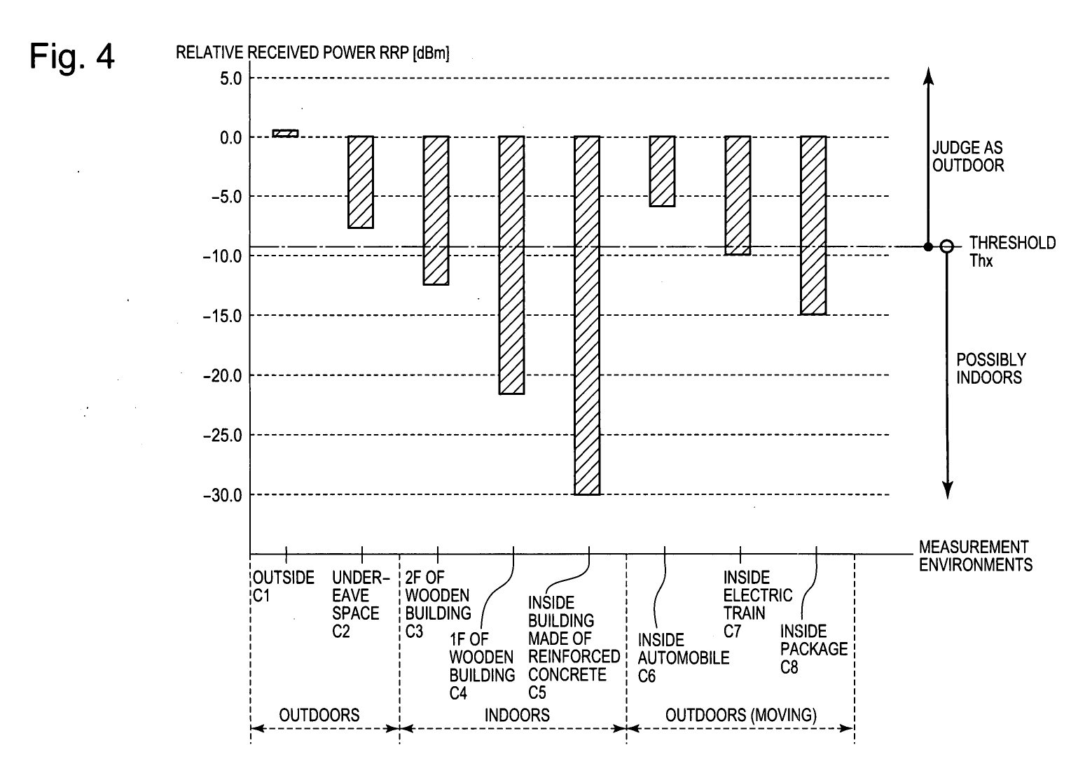

This judgment operation will be concretely described with reference to FIG. 4 showing an example of a correlation between the relative received power RRP and a measurement environment thereof. Here, measurement results of the relative received power RRP under respective environments of an outside C1, an under-eave space C2, a second floor C3 and a first floor C4 of a wooden building, an inside of a building C5 made of reinforced concrete, an inside of an automobile C6, an inside of an electric train C7, and an inside of a package (moving) C8 are shown in the drawing as an example.

Now, assume that the threshold Thx is set as illustrated. The judgment part 14 judges that the mobile terminal 1 is located outdoors because the relative received powers RRP respectively measured in the outside C1, under the eaves C2, and inside the automobile C5 is equal to or above the threshold Thx (i.e. because of favorable reception status of the positioning signal SG1 shown in FIG. 1) (Step S3).

At this time, the judgment part 14 gives the selector 23 shown in FIG. 2 the control signal SG2 instructing the selector 23 to select the attenuated transmission signal SG3b. Thereby, even when the mobile terminal 1 is located outdoors, the mobile terminal 1 is capable of sending signals at a power equal to or below a value of a signal power attenuated by the shielding object such as a wall of a house, and accordingly, avoiding a radio wave interference with existing communication systems.

Meanwhile, when a predetermined period of time passes after the above-described Step S3 (Step S4), the above-described Steps S1 and S2 will be executed again.

By contrast, the judgment part 14 judges that the mobile terminal 1 is possibly located indoors because the relative received powers RRP respectively measured on the second floor C3 and the first floor C4 of the wooden building, inside the building C5 made of reinforced concrete, inside the electric train C7, and inside the package C8 is below the threshold Thx, and then judges whether the mobile terminal 1 is located indoors or outdoors by comparing the movement distance LM calculated by the movement estimator 13 with a predetermined threshold Thy (Steps S5 and S6).

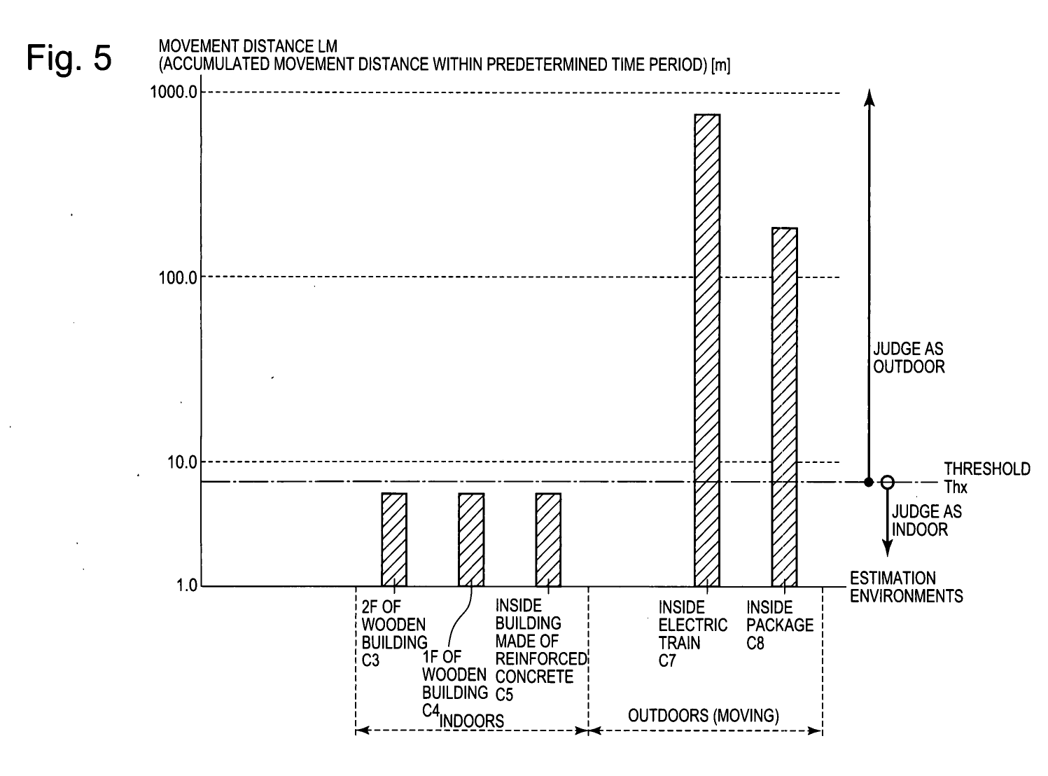

This judgment operation will be concretely described with reference to FIG. 5 showing an example of a correlation between the movement distance LM and estimated environment thereof. Here, calculation results of the movement distances LM (accumulated movement distances within a predetermined time period in this example) under respective environments of the second floor C3 and the first floor C4 of the wooden building, the inside of the building C5 made of reinforced concrete, the inside of the electric train C7, and the inside of the package C8 judged as possibly indoor in FIG. 4 are shown in the drawing as an example.

Now, assume that the threshold Thy is set as shown in FIG. 5. The judgment part 14 judges that the mobile terminal 1 is located indoors because the movement distances LM calculated on the second floor C3 and the first floor C4 of the wooden building, and inside the building C5 made of reinforced concrete are below the threshold Thy (i.e., because of small movement amount of the mobile terminal 1) (Step S7).

At this time, the judgment part 14 gives the selector 23 shown in FIG. 2 the control signal SG2 instructing the selector 23 to select the amplified transmission signal SG3a. In this case, since the power of the amplified transmission signal SG3a is attenuated by the shielding object such as a wall of a house when the signals leak from indoors to outdoors, it is possible to avoid radio wave interference with existing communication systems.

Meanwhile, when a predetermined period of time passes after the above-described Step S7 (Step S8), the above-described Steps S1 and S2 will be executed again.

By contrast, the judgment part 14 judges that the mobile terminal 1 is located outdoors because the movement distances LM calculated inside the electric train C7 and inside the package C8 are equal to or above the threshold Thy. At this time, the judgment part 14 gives the selector 23 shown in FIG. 2 the control signal SG2 instructing the selector 23 to select the attenuated transmission signal SG3b.

As described above, even in the case where the mobile terminal 1 is located inside the electric train C7 or inside the package C8 which may be judged as the indoor only on the basis of the relative received power RRP, it is possible to judge correctly that the mobile terminal 1 is located outdoors by use of the movement distance LM. Moreover, even when the relative received power RRP is uniformly reduced irrespective of indoor or outdoor location due to conditions such as the weather or an ambient environment, it is possible to perform the indoor/outdoor judgment accurately.

Moreover, although it is not illustrated, in the above-described Step S2, it is also possible to cause the judgment part 14 to compare an average value of the relative received powers RRP measured multiple times with the threshold Thx, and moreover, to make a comparison with the threshold Thx only in the case when the average values of the relative received powers RRP obtained multiple times are identical. In these cases, impacts of noise and the like included in the positioning signal SG1 can be reduced and thereby the accuracy (reliability) of the indoor/outdoor judgment can be improved. Here, since there are multiple GPS satellites in the sky, it is also possible to improve the accuracy of the indoor/outdoor judgment by comparing the relative received power RRP (or the average value thereof) with the threshold Thx only when the number of the GPS satellites from which the positioning signals are successfully received is equal to or above a predetermined number.

Similarly, in the above-described Step S6, it is also possible to cause the judgment part 14 to compare an average value of the movement distances LM calculated multiple times with the threshold Thy, and moreover, to make a comparison with the threshold Thy only in the case when the average values of the movement distances LM obtained multiple times are identical. In these cases, impacts of local movements, stops, or the like of the mobile terminal 1 can be reduced and thereby the accuracy of the indoor/outdoor judgment can be improved further.

The invention may also provide:

an indoor/outdoor judgment program causing a mobile terminal to execute:

measuring a received power of a radio signal received from outside the mobile terminal;

estimating a moving state of the mobile terminal from information included in the radio signal; and

judging whether the mobile terminal is located an indoor or an outdoor based on the received power and the moving state.

In program above, the program further causes the mobile terminal to execute controlling a transmission power of a radio signal to be sent to another communication device according to a result of the judgment.

Here, the present invention is not limited only to the above-described exemplary embodiment and it is apparent to those skilled in the art that various modifications are possible based on the description of the scope of claims. For example, the process of the indoor/outdoor judgment and the process of controlling the transmission power shown in the above-described exemplary embodiment may be provided as a program to be executed by a computer.

Further, it is noted that Applicant's intent is to encompass equivalents of all claim elements, even if amended later during prosecution.

What is claimed is:

1. A mobile terminal, comprising:
a power measurement part which measures a received power of a radio signal received from outside;
a movement estimator which estimates a moving state of the mobile terminal from an information included in the radio signal; and
a judgment part which judges whether the mobile terminal is located in an indoor location or an outdoor location, based on the received power and the moving state.

2. The mobile terminal according to claim 1, wherein the movement estimator calculates any of a movement distance and a movement speed of the mobile terminal as the moving state.

3. The mobile terminal according to claim 1, wherein the judgment part judges that the mobile terminal is located in the outdoor location when the received power is equal to or above a first threshold, and judges whether the mobile terminal is located in the indoor location or in the outdoor location based on the moving state when the received power is below the first threshold.

4. The mobile terminal according to claim 3, wherein the judgment part judges that the mobile terminal is located in the outdoor location when an average value of the received powers measured a plurality of times by the power measurement part is equal to or above the first threshold, and makes the judgment based on the moving state when the average value is below the first threshold.

5. The mobile terminal according to claim 4, wherein, only when the average values obtained a plurality of times are identical, the judgment part compares the average value with the first threshold.

6. The mobile terminal according to claim 1, wherein
the movement estimator calculates any of a movement distance and a movement speed of the mobile terminal as the moving state, and
the judgment part judges that the mobile terminal is located in the outdoor location when the received power is below a first threshold and any of the movement distance and the movement speed is equal to or above a second threshold, and judges that the mobile terminal is located in the indoor location when the received power is below the first threshold and any of the movement distance and the movement speed is below the second threshold.

7. The mobile terminal according to claim 6, wherein the judgment part judges that the mobile terminal is located in the outdoor location when an average value of any of the movement distances and the movement speeds calculated by the movement estimator a plurality of times, is equal to or above the second threshold, and judges that the mobile terminal is located in the indoor location when the average value is below the second threshold.

8. The mobile terminal according to claim 7, wherein, only when the average values obtained a plurality of times are identical, the judgment part compares the average value with the second threshold.

9. The mobile terminal according to claim 1, further comprising:
a transmitter which transmits the radio signal to another communication device,
wherein the judgment part controls a transmission power of the radio signal to be sent from the transmitter according to a result of the judgment.

10. The mobile terminal according to claim 9, wherein the judgment part instructs the transmitter to set the transmission power equal to or below a predetermined power value when judging that the mobile terminal is located in the outdoor location.

11. The mobile terminal according to claim 1, wherein the power measurement part measures a received power of the radio signal relative to a reference power as the received power.

12. The mobile terminal according to claim 1, wherein the radio signal comprises a positioning signal transmitted from an artificial satellite.

13. An indoor/outdoor judgment method for a mobile terminal, comprising:
measuring a received power of a radio signal received from outside the mobile terminal;
estimating a moving state of the mobile terminal from information included in the radio signal; and
judging whether the mobile terminal is located in an indoor location or an outdoor location based on the received power and the moving state.

14. The indoor/outdoor judgment method according to claim 13, wherein the estimating includes calculating any of a movement distance and a movement speed of the mobile terminal as the moving state.

15. The indoor/outdoor judgment method according to claim 13,
wherein the judging includes a judgment that the mobile terminal is located in the outdoor location when the received power is equal to or above a first threshold, and
wherein the judging includes an judgment whether the mobile terminal is located in the indoor location or in the outdoor location based on the moving state when the received power is below the first threshold.

16. The indoor/outdoor judgment method according to claim 15,
wherein the judging includes a judgment that the mobile terminal is located in the outdoor location when an average value of the received powers measured a plurality of times is equal to or above the first threshold, and
wherein the judging is made based on the moving state when the average value is below the first threshold.

17. The indoor/outdoor judgment method according to claim 16, wherein the judging is conducted such that, only when the average values obtained a plurality of times are identical, the average value is compared with the first threshold.

18. The indoor/outdoor judgment method according to claim 13,
wherein the estimating includes calculating any of a movement distance and a movement speed of the mobile terminal as the moving state,
wherein the judging includes a judgment that the mobile terminal is located in the outdoor location when the received power is below a first threshold and any of the movement distance and the movement speed is equal to or above a second threshold, and
wherein the judging includes a judgment that the mobile terminal is located in the indoor location when the received power is below the first threshold and any of the movement distance and the movement speed is below the second threshold.

19. The indoor/outdoor judgment method according to claim 18,
wherein the judging includes a judgment that the mobile terminal is located the outdoor when an average value of any of the movement distances and the movement speeds calculated a plurality of times is equal to or above the second threshold, and
wherein the judging includes a judgment that the mobile terminal is located the indoor when the average value is below the second threshold.

20. The indoor/outdoor judgment method according to claim 19, wherein the judging includes, only when the average values obtained a plurality of times are identical, the average value is compared with the second threshold.
